(19) United States
(12) Patent Application Publication
(10) Pub. No.: US 2022/0277499 A1
(43) Pub. Date: Sep. 1, 2022

(54) SYSTEMS AND METHODS FOR DOCUMENT PROCESSING

(71) Applicant: Arbi, Inc., Allston, MA (US)

(72) Inventors: Yishu YANG, Allston, MA (US); Raj AGRAWAL, Cambridge, MA (US)

(21) Appl. No.: 17/634,866

(22) PCT Filed: Aug. 12, 2020
(86) PCT No.: PCT/US20/46040

§ 371 Date: Feb. 11, 2022

Related U.S. Application Data
(60) Provisional application No. 62/886,333, filed on Aug. 13, 2019.

(51) Int. Cl. G06T 11/20; G06F 16/93; G06F 16/901; G06F 40/40; G06F 3/0481; G06F 3/04842

(52) U.S. Cl. CPC G06T 11/206; G06F 16/93; G06F 16/9024; G06F 40/40; G06F 3/0481; G06F 3/04842; G06T 2200/24

(57) ABSTRACT

Among other things, technologies disclosed herein include a method or a system able to process documents to extract features, predict outcomes and visualize feature relations.

### BACKGROUND

This description relates to technologies in document processing and language understanding.

### SUMMARY

Techniques described in this document are provided for processing documents, extracting features from documents, inferring contexts of languages, and visualizing features in documents.

Among other advantages of these aspects, features, and implementations are the following. Large-scale information can be automatically retrieved. Case outcomes can be predicted. Human labor to identify relevant document can be reduced or eliminated.

In general, in one aspect, implementations include a method comprising: (a) receiving, by a computing device, one or more documents, (b) displaying, by a computing device, a region of a document, and (c) providing, by a computing device, an interface to a first user for making an annotation on the portion of a document. In some embodiments, a document is in a form of image, in a form of texts, or mixed. In some embodiments, implementations include providing an interface to a first user comprises presenting a question to the first user. In some embodiments, providing an interface to a first user comprises presenting a task instruction to the first user. In some cases, providing an interface to a first user comprises enabling the first user to zoom in or out on the document.

In some embodiments, making an annotation comprises identifying one or more texts, identifying one or more sentences, identifying one or more paragraphs, or identifying a start point and an end point of texts, or a combination of them.

Some implementations of the method include recording a sequence of annotation steps. In some embodiments, the method records a time of making an annotation. In some cases, the method records one or more actions applied to a displayed region of a document.

Some implementations of the method include comparing an annotation with a set of pre-annotations. A pre-annotation may be generated by a first user or a second user. In some applications, a pre-annotation is generated an algorithm. In some embodiments, comparing the annotation with a set of pre-annotations comprises evaluating a deviation of the annotation from the set of pre-annotations. In some cases, comparing the annotation with a set of pre-annotations comprises evaluating a deviation of the annotation from the set of pre-annotations.

Some implementations of the method include providing an evaluation result.

Some implementations of the method include providing an explanation of a difficulty in making an annotation.

Some implementations of the method include providing an improvement tip on making an annotation.

Some implementations of the method include generating an algorithm of annotation learned from a sequence of actions within the making an annotation.

In general, in another aspect, implementations include a method comprising: (a) receiving, by a computing device, one or more documents, (b) extracting, by a computing device, one or more features from the one or more documents, and (c) predicting, by a computing device, one or more outcomes associated with the one or more documents based on the one or more features. In some implementations, extracting two or more features is based on a language understanding model. The language understanding model comprises a neural language model.

In some implementations, predicting one or more outcomes is based on a network model, the network model comprising nodes representing the one or more outcomes and the one or more features and edges representing modulations among nodes.

In some implementations, a network model arranges the one or more outcomes in terms of temporal occurrences. In some embodiments, a first outcome at a first temporal occurrence is modulated by outcomes at a second temporal occurrence prior to the first temporal occurrence. In some cases, two outcomes taking place at a same temporal occurrence are independent. In some networks, each outcome is modulated by at least one feature. In some embodiments, each outcome is modulated by all of the two or more features.

In some implementations, a network model arranges the two or more features in terms of temporal occurrences.

In some implementations, a first outcome at a first occurrence is modulated by outcomes and features at a second temporal occurrence prior to the first temporal occurrence.

In some implementations, a network model arranges two or more features without a temporal occurrence. In some embodiments, a network model arranges two or more features as independent variables.

In some implementations, modulation of a node by one or more upstream nodes is based on a Bayesian probabilistic model, a regression model, a neural network model, a support vector machine, a game theoretic model, or a minimax model, or a combination of them. In some embodiments, modulation of a node by one or more upstream nodes is based on two or more models. In some embodiments, modulation of a node by one or more upstream nodes is based a model randomly selected from two or more models by fitting a training data set. In some cases, two or more modulation models comprise a Bayesian probabilistic model and a neural network model.

In general, in another aspect, implementations include a method comprising: (a) receiving, by a computing device, a dataset, the dataset comprising: (1) two or more first data objects, and (2) two or more second data objects associated with the two or more first data objects, wherein a first data object is associated with at least two second data objects; and (b) rendering, by a computing device, a graphical model overlaying on two or more contours to visualize associations between the two or more first data objects and the two or more second data objects.

In some embodiments, a first data object comprises an event, a product, a group, an entity, a tribunal, a company, a class, or a family. In some embodiments, a second data object comprises an event, a product, a participant, a person, an entity, a tribunal member, an employee, a teacher, a student, or a family member. In some embodiments, a first data object represents a group and a second data object represents a member of the group.

Some implementations of the method comprise creating the graphical model, wherein the graphical model having nodes and edges. In some embodiments, the graphical model comprises a directed edge, an undirected directed edge, or both. In some embodiments, the directed edge represents a hierarchical relation in the association between the two or more first data objects and the two or more second data objects. In some cases, creating the graphical model comprises representing a second data object by a node. In some applications, creating the graphical model comprises assigning an edge to a pair of nodes when a pair of second data objects represented by the pair of nodes is commonly associated with a first data object. In some embodiments, creating the graphical model comprises assigning edges to a group of second data objects by forming the group of second data objects as a complete graph in the graphical model. In various applications, creating the graphical model comprises assigning edges to a group of second data objects by forming the group of second data objects as an incomplete graph in the graphical model. In some embodiments, creating the graphical model comprises assigning edges to a group of second data objects by forming the group of second data objects as a bipartite graph in the graphical model. In some implementations, creating the graphical model comprises assigning edges to a group of second data objects by forming the group of second data objects as a planer graph in the graphical model. In some embodiments, creating the graphical model comprises assigning edges to a group of second data objects by forming the group of second data objects as a directed graph in the graphical model. In some cases, creating the graphical model comprises grouping two or more edges between a pair of nodes into a hyperedge.

In some embodiments, a contour represents the number of occurrences of a second data object in the dataset. The number of the contours may be determined by the maximum number of occurrences of second data objects in the dataset.

In some embodiments, rendering a graphical model overlaying on two or more contours comprises allocating a node of the graphical model as a center of the two or more contours, the node representing a second data object. Rendering a graphical model overlaying on two or more contours comprises allocating a node of the graphical model on a contour based on: (1) the node representing a second data object, and (2) the number of occurrences of the second data object in the dataset.

In some embodiments, rendering a graphical model overlaying on two or more contours comprises optimizing locations of nodes of the graphical model on the two or more contours. In some cases, the optimization comprises minimizing an overlapping area between one area captured by a first group of associated second data objects and another area captured by a second group of associated second data objects. In some applications, the optimization comprises minimizing a total length of edges linking nodes to a center of the two or more contours.

In some embodiments, two of the contours are concentric. A contour can be in a regular shape, or in an irregular shape, in a shape of a circle, in a shape of a sphere, in a shape of a rectangle, in a shape of a polygon, or in a shape with symmetry, or a combination of them.

Some implementations of the method include providing, by a computing device, a user interface for a user to interact with a dataset. The user interface allows the user to apply filtering on the two and more first data objects. In some embodiments, the rendering, in response to the user applying filtering, emphasizes components of the graphical model corresponding to filtered first data objects. In some embodiments, the rendering, in response to the user applying filtering, emphasizes components of the graphical model corresponding to associations of filtered first data objects. In some cases, the rendering, in response to the user applying filtering, de-emphasizes components of the graphical model not corresponding to filtered first data objects. In some applications, the rendering, in response to the user applying filtering, de-emphasizes components of the graphical model not corresponding to associations of filtered first data objects.

In some embodiments, the user interface allows the user to apply filtering on the two and more second data objects. In some embodiments, the rendering, in response to the user applying filtering, emphasizes components of the graphical model corresponding to filtered second data objects. In some cases, the rendering, in response to the user applying filtering, emphasizes components of the graphical model corresponding to associations of filtered second data objects. In some applications, the rendering, in response to the user applying filtering, de-emphasizes components of the graphical model not corresponding to filtered second data objects. In some embodiments, the rendering, in response to the user applying filtering, de-emphasizes components of the graphical model not corresponding to associations of filtered second data objects.

Some implementations of the method include providing, by a computing device, a user interface for a user interact with a component of the graphical model. In some embodiments, the user applies filtering on the dataset in response to the user interacting with a component of the graphical model. In some embodiments, the rendering, in response to the user selecting a node of the graphical model, emphasizes the selected node. In some embodiments, the rendering, in response to the user selecting a node of the graphical model, emphasizes nodes of the graphical model directly linking to the selected node. In some cases, the rendering, in response to the user selecting a node of the graphical model, de-emphasizes nodes of the graphical model not directly linking to the selected node. In some applications, the rendering, in response to the user selecting a node of the graphical model, de-emphasizes edges of the graphical model not linking the selected node.

In some embodiments, the rendering, in response to the user selecting an edge of the graphical model, emphasizes the selected edge. In some embodiments, the rendering, in response to the user selecting an edge of the graphical model, emphasizes nodes of the graphical model directly linking by the selected edge. In some cases, the rendering, in response to the user selecting an edge of the graphical model, de-emphasizes nodes of the graphical model not directly linking by the selected edge. In some applications, the rendering, in response to the user selecting an edge of the graphical model, de-emphasizes non-selected edges of the graphical model.

In some embodiments, the rendering, in response to the user selecting a subgraph of the graphical model, emphasizes the area captured by the selected subgraph. In some cases, the rendering, in response to the user selecting a subgraph of the graphical model, emphasizes the nodes of the selected subgraph. In some applications, the rendering, in response to the user selecting a subgraph of the graphical model, emphasizes the edges of the selected subgraph.

Some implementations of the method include providing, by a computing device, a user interface for a user to select a contour. In some embodiments, the rendering, in response to the user selecting the contour, emphasizes the contour. In some cases, the rendering, in response to the user selecting the contour, de-emphasizes a non-selected contour. In some applications, the rendering, in response to the user selecting the contour, emphasizes a node on a selected contour. In some scenarios, the rendering, in response to the user selecting the contour, de-emphasizes a node on a non-selected contour. In some embodiments, the rendering, in response to the user selecting the contour, emphasizes an edge directly connecting to a node on a selected contour. In some embodiments, the rendering, in response to the user selecting the contour, de-emphasizes an edge connecting to both nodes on a non-selected contour.

Some implementations of the method include providing, by a computing device, a user interface for a user to select a time during a time course covering the dataset. In some embodiments, the rendering, in response to the user selecting the time, emphasizes a subgraph of the graphical model corresponding to data objects present at the selected time. In some cases, the rendering, in response to the user selecting the time, de-emphasizes components of the graphical model not corresponding data objects present at the selected time.

In various embodiments, the rendering emphasizes a visual component by adding, thickening, highlighting, color-changing, style-changing, shading, or texturing, or a combination of them, the visual component.

In various embodiments, the rendering de-emphasizes a visual component by thinning, darkening, graying, color-changing, de-coloring, style-changing, dashing, dotting, shading, or removing, or a combination of them, the visual component.

Some implementations of the method are performed in software executable on a computing device (e.g., personal computer, laptop, tablet, or a mobile device). Some implementations are realized in a server-client computing environment. Some implementations are achieved in hardware in ASIC, or FPGA, or an embedded system.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is an example block diagram of a language understanding system.

FIG. 2 is an example of a computer system.

FIG. 3 is an example of a cloud computing system.

FIGS. 4-5 are examples of a document processing system.

FIGS. 6-7 are examples of feature extraction.

FIGS. 8A-8D are examples of outcome prediction.

FIGS. 9A-9B are examples of modulation in predictive network models.

FIG. 10 is an example of a dataset.

FIGS. 11-19 are examples of feature visualization.

### DETAILED DESCRIPTION

In the following description, for the purposes of explanation, specific details are set forth in order to provide a thorough understanding of the disclosed technologies. It will be apparent, however, that the disclosed technologies may be practiced without these specific details. In other instances, well-known structures and devices are shown in block diagram form in order to avoid unnecessarily obscuring the disclosed technologies.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such an element represents one or multiple signal paths (e.g., a bus, a wired communication channel, a wireless communication channel, etc.), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description.

The term “processor” is used broadly to include, for example, a hardware comprising electronic circuitry able to perform machine instructions designated based on described technologies. This term is used interchangeably with “controller” or “processing circuit”.

The term “one or more” means a function being performed by one element, a function being performed by more than one element, e.g., in a distributed manner, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first module could be termed a second module, and, similarly, a second module could be termed a first module, without departing from the scope of the various described embodiments. The first module and the second module are both modules, but they are not the same module.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Language Understanding System

Language understanding systems are important tools for researchers to automatically process a large number of documents.

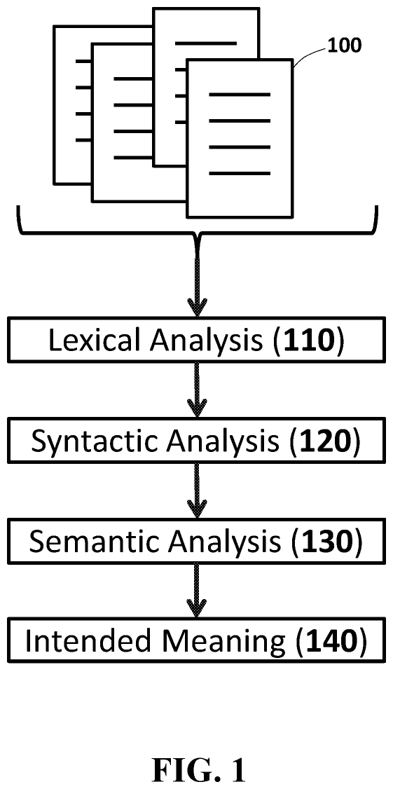

In general, FIG. 1 illustrates a system for language understanding. A language understanding system may include a number of analysis stages. When the system receives texts or documents 100 (e.g., webpages, blogs, news, academic papers, technical reports, speech transcripts, medical records, financial statements, legal documents, court decisions, etc.), a language understanding process starts with lexical analysis 110 to analyze individual words, for example, in phonology and morphology. Syntactic analysis 120 considers language in the level of sentences, since a sentence expresses a proposition, an idea, or a thought, and says something about some real or imaginary world. Extracting the meaning from a sentence is thus a key issue. Following syntactic analysis is semantic analysis 130 that derives intended meaning 140 for sentences in question.

The steps of lexical analysis 110, syntactic analysis 120, semantic analysis 130, and intended meaning derivation 140 may not be implemented as individual processing stages. In some embodiments, for example, a language understanding system employs deep learning to integrate lexical analysis, syntactic analysis, and semantic analysis in a single stage to infer intended meaning.

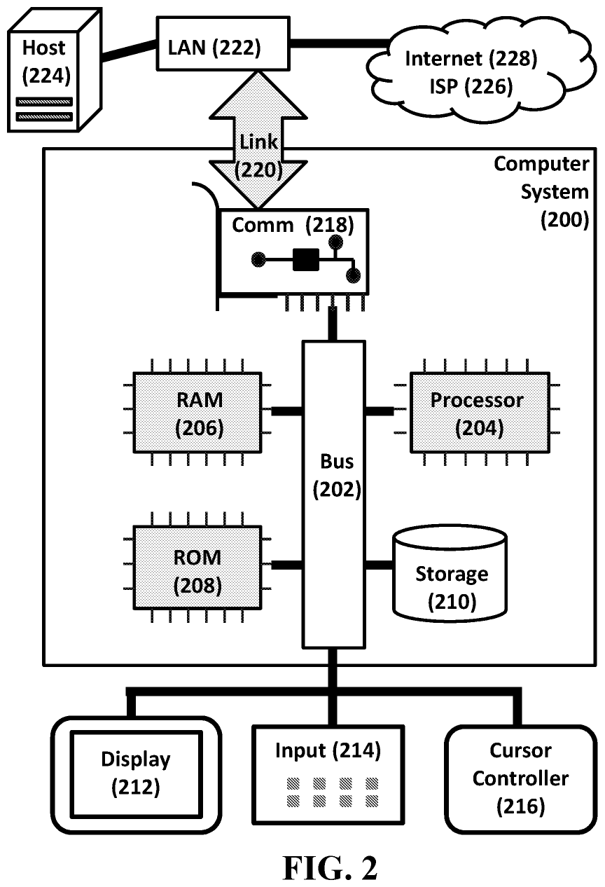

In various implementations, a language understanding system comprises a computer system, or is coupled with a computer system, or both. FIG. 2 illustrates a computer system 200. In an implementation, the computer system 200 is a special-purpose computing device. The special-purpose computing device is hard-wired to perform the described technologies or includes digital electronic devices such as one or more application-specific integrated circuits (ASICs) or field programmable gate arrays (FPGAs) that are persistently programmed to perform the technologies, or may include one or more general purpose hardware processors programmed to perform the technologies pursuant to program instructions in firmware, memory, other storage, or a combination. Such special-purpose computing devices may also combine custom hard-wired logic, ASICs, or FPGAs with custom programming to accomplish the technologies. In various embodiments, the special-purpose computing devices are desktop computer systems, portable computer systems, handheld devices, network devices or any other device that incorporates hard-wired and/or program logic to implement the techniques.

In an embodiment, the computer system 200 includes a bus 202 or other communication mechanism for communicating information, and a hardware processor 204 coupled with a bus 202 for processing information. The hardware processor 204 is, for example, a general-purpose microprocessor. The computer system 200 also includes a main memory 206, such as a random-access memory (RAM) or other dynamic storage device, coupled to the bus 202 for storing information and instructions to be executed by processor 204. In one implementation, the main memory 206 is used for storing temporary variables or other intermediate information during execution of instructions to be executed by the processor 204. Such instructions, when stored in non-transitory storage media accessible to the processor 204, render the computer system 200 into a special-purpose machine that is customized to perform the operations specified in the instructions.

In an embodiment, the computer system 200 further includes a read only memory (ROM) 208 or other static storage device coupled to the bus 202 for storing static information and instructions for the processor 204. A storage device 210, such as a magnetic disk, optical disk, solid-state drive, or three-dimensional cross point memory is provided and coupled to the bus 202 for storing information and instructions.

In an embodiment, the computer system 200 is coupled via the bus 202 to a display 212, such as a cathode ray tube (CRT), a liquid crystal display (LCD), plasma display, light emitting diode (LED) display, or an organic light emitting diode (OLED) display for displaying information to a computer user. An input device 214, including alphanumeric and other keys, is coupled to bus 202 for communicating information and command selections to the processor 204. Another type of user input device is a cursor controller 216, such as a mouse, a trackball, a touch-enabled display, or cursor direction keys for communicating direction information and command selections to the processor 204 and for controlling cursor movement on the display 212. This input device typically has two degrees of freedom in two axes, a first axis (e.g., x-axis) and a second axis (e.g., y-axis), that allows the device to specify positions in a plane.

According to one embodiment, the techniques herein are performed by the computer system 200 in response to the processor 204 executing one or more sequences of one or more instructions contained in the main memory 206. Such instructions are read into the main memory 206 from another storage medium, such as the storage device 210. Execution of the sequences of instructions contained in the main memory 206 causes the processor 204 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 210. Volatile media includes dynamic memory, such as the main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 202. Transmission media can also take the form of acoustic or light waves, such as those generated during radio-wave and infrared data communications.

In an embodiment, various forms of media are involved in carrying one or more sequences of one or more instructions to the processor 204 for execution. For example, the instructions are initially carried on a magnetic disk or solid-state drive of a remote computer. The remote computer loads the instructions into its dynamic memory and sends the instructions over a telephone line using a modem. A modem local to the computer system 200 receives the data on the telephone line and use an infrared transmitter to convert the data to an infrared signal. An infrared detector receives the data carried in the infrared signal and appropriate circuitry places the data on the bus 202. The bus 202 carries the data to the main memory 206, from which processor 204 retrieves and executes the instructions. The instructions received by the main memory 206 may optionally be stored on the storage device 210 either before or after execution by processor 204.

The computer system 200 also includes a communication interface 218 coupled to the bus 202. The communication interface 218 provides a two-way data communication coupling to a network link 220 that is connected to a local network 222. For example, the communication interface 218 is an integrated service digital network (ISDN) card, cable modem, satellite modem, or a modem to provide a data communication connection to a corresponding type of telephone line. As another example, the communication interface 218 is a local area network (LAN) card to provide a data communication connection to a compatible LAN. In some implementations, wireless links are also implemented. In any such implementation, the communication interface 218 sends and receives electrical, electromagnetic, or optical signals that carry digital data streams representing various types of information.

The network link 220 typically provides data communication through one or more networks to other data devices. For example, the network link 220 provides a connection through the local network 222 to a host computer 224 or to a cloud data center or equipment operated by an Internet Service Provider (ISP) 226. The ISP 226 in turn provides data communication services through the world-wide packet data communication network now commonly referred to as the “Internet” 228. The local network 222 and Internet 228 both use electrical, electromagnetic or optical signals that carry digital data streams. The signals through the various networks and the signals on the network link 220 and through the communication interface 218, which carry the digital data to and from the computer system 200, are example forms of transmission media. In an embodiment, the network 220 contains a cloud or a part of the cloud.

The computer system 200 sends messages and receives data, including program code, through the network(s), the network link 220, and the communication interface 218. In an embodiment, the computer system 200 receives code for processing. The received code is executed by the processor 204 as it is received, and/or stored in storage device 210, or other non-volatile storage for later execution.

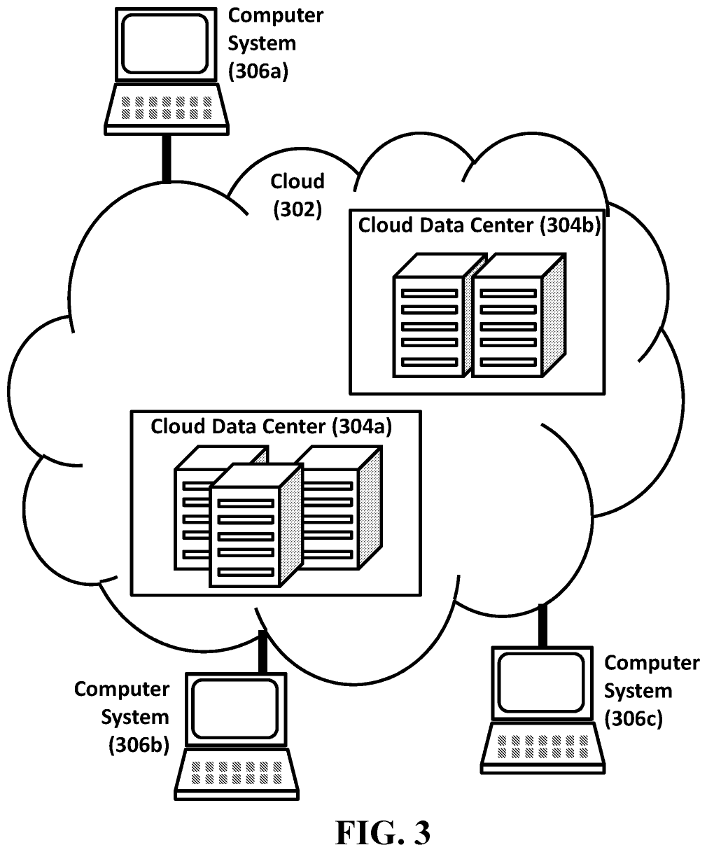

FIG. 3 illustrates an example of a “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 3, the cloud computing environment includes cloud data centers (e.g., 304a and 304b) that are interconnected through the cloud 302. Data centers 304a and 304b provide cloud computing services to computer systems 306a, 306b and 306c connected to cloud 302.

A cloud computing environment (e.g., shown in FIG. 3) includes one or more cloud data centers. In general, a cloud data center, for example the cloud data center 304a shown in FIG. 3, refers to the physical arrangement of servers that make up a cloud, for instance the cloud 302 or a particular portion of a cloud. In some examples, servers are physically arranged in a cloud data center into rooms, groups, rows, and racks. A cloud data center has one or more zones, which include one or more rooms of servers. Each room has one or more rows of servers, and each row includes one or more racks. Each rack includes one or more individual server nodes. In some implementations, servers in zones, rooms, racks, and/or rows are arranged into groups based on physical infrastructure requirements of the data center facility, which include power, energy, thermal, heat, and/or other requirements. In an embodiment, the server nodes are similar to the computer system described in FIG. 2. The data center 304a has many computer systems distributed through many racks.

The cloud 302 includes cloud data centers 304a and 304b along with the network and networking resources (for example, networking equipment, nodes, routers, switches, and networking cables) that interconnect the cloud data centers 304a and 304b and allow the computer systems 306a, 306b and 306c to have access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

Computer systems (e.g., 306a, 306b and 306c) or cloud computing services are connected to the cloud 302 through network links and network adapters. In an embodiment, the computer systems (e.g., 306a, 306b and 306c) are implemented as various computing devices, for example servers, desktops, laptops, tablet, smartphones, Internet of Things (IoT) devices, and consumer electronics. In an embodiment, the computer systems (e.g., 306a, 306b and 306c) are implemented in or as a part of other systems.

### Preprocess and Feature Extraction

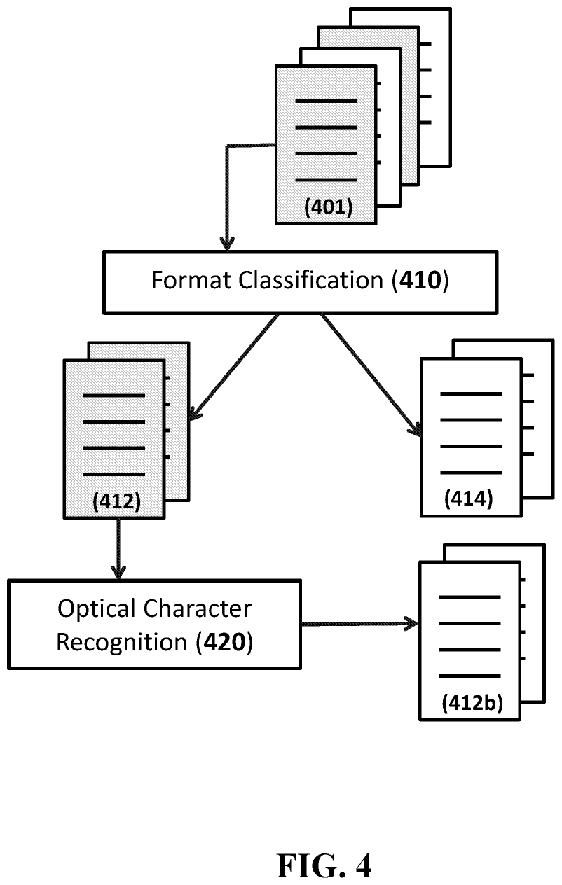

In various implementations, a language understanding system includes a text identification process. Referring to FIG. 4, when a language understanding system receives a document 401, a text identification process invokes a classifier 410 to determine if the document is in a form of image 412 (e.g., a scanned document) or in a form of text 414 (e.g., a Microsoft Word file). When a document is classified as an image, a text identification process begins with optical character recognition 420 to convert image-based document 412 into text-based document 412b. Then, the text identification process checks the language and spelling errors.

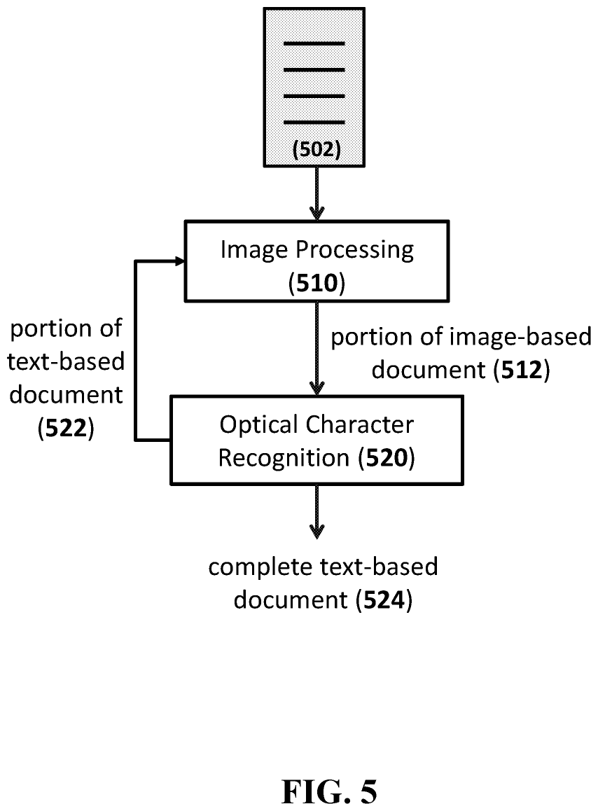

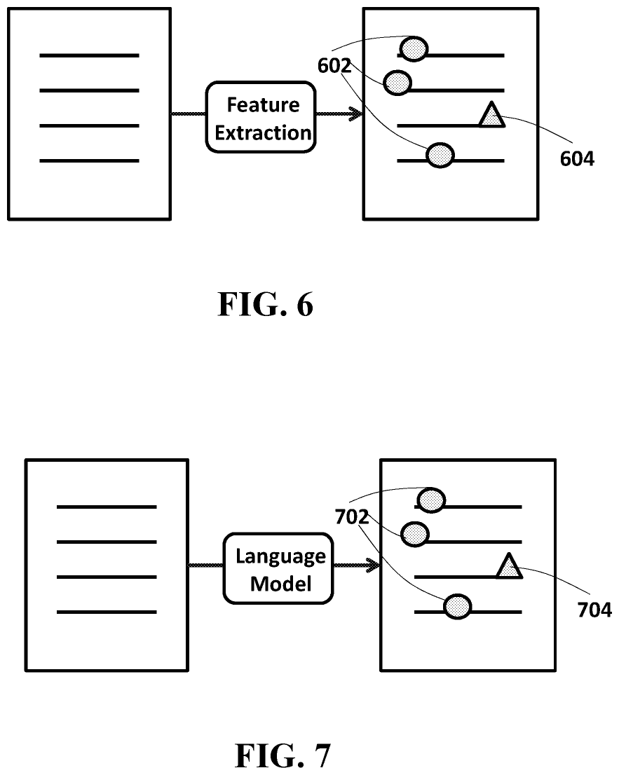

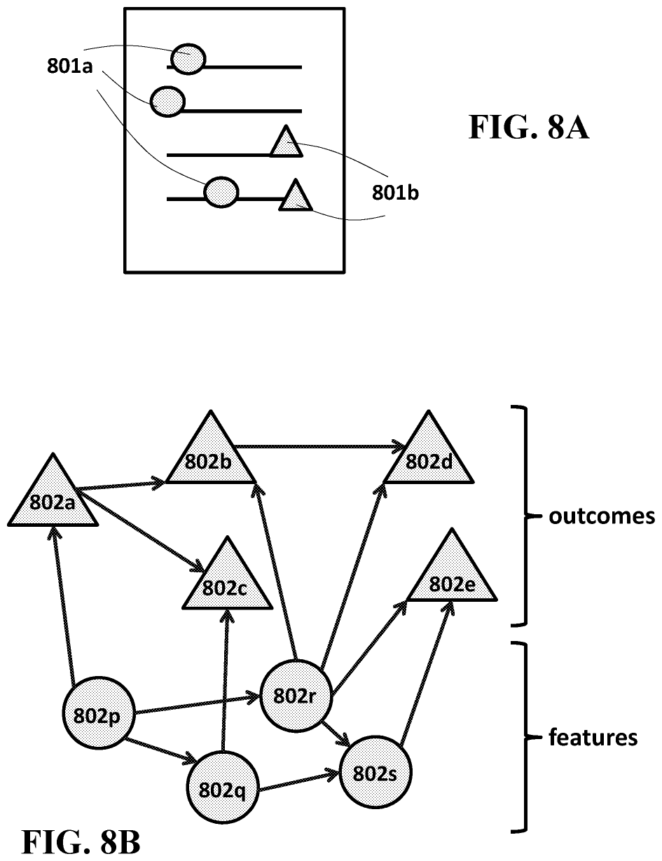

In some embodiments, a text identification process iteratively performs image processing and optical character recognition to convert image-based document to text-based document. Referring to FIG. 5, when a language understanding system receives an image-based document 502, an image processing or computer vision algorithm 510 is used to segment a portion of image-based document 512, which is then fed to optical character recognition 520 to recognize texts. The portion of text-based document 522 is then integrated with the original document 502, followed by image process 510 for segmenting another portion of the image-based document. The other portion may or may not overlap with the initial portion. The processing loop is performed until the whole document is turned into text-based document 524.

In various implementations, a language understanding system includes a feature extraction process. Feature extraction may be semi-automatic or fully automatic.

In some embodiments where feature extraction is semi-automatic, a computing device displays a region of a document to a user; a displayed region may be a portion of the document or may be the whole document. In some cases, a computing device provides a user interface to a user for making annotation. Not-limiting examples of a user interface are described below:
(1) A user interface comprises a means allowing a user to zoom in or zoom out on a document.
(2) A user interface presents instructions to a user, who can then follow the instructions to perform one or more annotation tasks.
(3) A user interface presents a question, and a computing device enables a user to label an answer. Labeling can be applied to texts, images, figures, and/or tables. Labeling can be applied to a structural component of a document, such as titles, authors, parties involved or discussed in the document, entities, abstract, table of contents, paragraphs, sections, footnotes, citations, references, and index. Methods of labeling include, but not limited to, highlighting, marking a start and an end of a region, pointing to a word, pointing to a phrase, pointing to a clause, pointing to a sentence, pointing to a paragraph, pointing to a page, etc.
(4) A user interface presents a question and one or more possible answers automatically extracted from the document, and then a user chooses one or more best answers in response to the question. In some cases, when there is no good answer matching the question, the user interface allows the user to select a not applicable statement (e.g., no applicable answer, none of other answers match to the question, need more information, etc.). In some embodiments, the user interface terminates such a question-answer session. In some embodiments, the user interface extracts another set of answers for the user to choose, till at least one answer is chosen, or till a maximum number of question-answer sessions is reached, or till a maximum time has passed.

In some embodiments where a feature extraction process involves human-assisted annotation, the system records a sequence of annotation steps. The system may record one or more actions applied to a displayed region of a document, followed by analyzing the actions associated with the document contents. In some cases, the system records a timestamp of making annotation. In some applications, the system records an amount of time spent on making annotation.

In some embodiments, a feature extraction process compares automatic or human-assisted annotation (e.g., an annotation result, an annotation step, an annotation interaction, etc.) or both with a set of previously recorded annotation. Pre-annotation may be automatically generated by one or more algorithms. Pre-annotation comprises raw data, a summary (e.g., statistics, time series, text descriptions), and/or processed data (e.g., structured data having been processed from unstructured data; recognized patterns; transformed data). In some cases, pre-annotation is generated with human assistance by a same user, or by another user, or by two or more users including the same user or not including the same user. A comparison evaluates how much deviation of the current annotation away from pre-annotation. In some applications, a comparison results in a combination of the current annotation and pre-annotation and updates the pre-annotation for future use. A combination can be applied to raw data, to a summary, and/or to processed data. In some embodiments, a combination includes adding the current annotation to pre-annotation and/or removing part of pre-annotation, followed by forming updated pre-annotation.

In some embodiments, a feature extraction process provides an explanation of a difficulty in making annotation.

In some embodiments, a feature extraction process provides an improvement tip on making annotation.

In some embodiments, a feature extraction process generates an algorithm of automatic annotation learned from a sequence of actions made during a human-assisted annotation session.

In some embodiments, a feature extraction process organizes extracted features in a dataset.

### Outcome Prediction

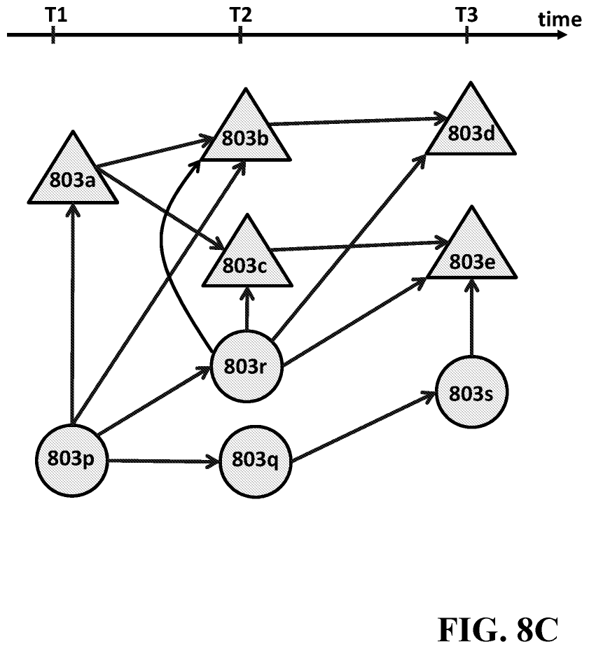

In various implementations, a language understanding system includes an outcome prediction process. Referring to FIG. 8A, a feature extraction process extracts one or more features 801a. One or more outcomes 801b may be identified in a feature extraction step. In some implementations, a feature (e.g., one of features 801a in FIG. 8A) is deemed as an outcome, and one or more other features are turned into predicting variables. In some applications, raw data includes reviews of a product; outcomes may include if a buyer will buy a product and the quantity of the buyer the buyer will purchase; features may include attitudes of the reviews, words used in the reviews, time of the reviews provided, etc. In some applications, raw data includes documents of a legal case; outcomes may include a law under the dispute, selection of a judge or arbitrator, and winning or lose, and an award amount; features may include industry types, entities, countries, times, etc. Computationally, an outcome or a feature can be described by a discrete random variable/vector or a continuous random variable/vector.

In some embodiments, an outcome prediction process is based on a network model, such as FIG. 8B. A network model includes nodes representing outcomes (e.g., 802a, 802b, 802c, 802d, 802e) and features (e.g., 802p, 802q, 802r, 802s); a directed edge linking a pair of nodes represents a modulation relation from an upstream node to a downstream node. In some applications, an outcome is modulated by one or more features and/or one or more other outcomes; for example in FIG. 8B, an outcome 802a is modulated only by a feature 802p, an outcome 802c is modulated by both another outcome 802a and a feature 802q, and an outcome 802e is modulated by only features 802r and 802s. In some cases, a feature is modulated by one or more other features; for instance in FIG. 8B, a feature 802s is modulated by features 802r and 802q.

In some embodiments, a network model arranges outcomes or features or both in terms of temporal occurrences or in terms of logical steps. In some embodiments, a temporal or logical sequence is specified by an expert. In some embodiments, a temporal or logical sequence is learned from feature extraction processing. In some network models, a node at a later temporal occurrence or logical step is modulated by one or more nodes at a previous time or logical step (e.g., one upstream step, or two or more upstream steps), or at two different previous times or logical steps. In some network models, two nodes at a same temporal occurrence or logical step are independent, or one node can be modulated by the other.

In the example of FIG. 8C, outcomes (e.g., 803a, 803b, 803c, 803d, 803e) are characterized in a temporal/logical domain at three points: T1, T2, and T3. The time/logic points can be exact times in our real world, or they merely symbolically represent a temporal or logical sequence. In this example, outcome 803a is located at T1, outcomes 803b and 803c are located at T2, and outcomes 803d and 803e are located at T3. In the example of FIG. 8C, features (e.g., 803p, 803q, 803r, 803s) are also characterized in a temporal/logical domain, where feature 803p is located at T1, features 803r and 803q are located at T2, and feature 803s is located at T3. structure.

In some embodiments, a network model does not arrange outcomes in terms of temporal occurrences or in terms of logical steps. In some embodiments, a network model does not arrange features in terms of temporal occurrences or in terms of a logical sequence.

In some embodiments, a network model arranges outcomes in terms of temporal occurrences or in terms of logical steps and does not arrange features in terms of temporal occurrences or in terms of a logical sequence. FIG. 8D shows an example, where outcomes (e.g., 804a, 804b, 804c, 804d, 804e) are characterized in a temporal or logical domain with three points (T1, T2, T3) and features (e.g., 804p, 804q, 804r, 804s) are not. In some applications, a modulation structure from a feature to an outcome is learned from data or specified by an expert. In some cases, some features have a same modulation structure on some outcomes, and these features together can be deemed as a hypernode; for instance in FIG. 8D, all features modulate to all outcomes, so the union of all features can be graphically described as a hypernode 804y. In some embodiments, a modulation structure among features is learned from data. In some embodiments, there is no modulation structure among features; in other words, the features are treated independent.

In general, a modulation structure of a network model is learned from the data. In some cases, a modulation structure is specified by an expert. In some applications, an initial modulation structure is seeded by an expert, and a learning algorithm is employed to find an optimal modulation by treating the initial modulation as a hard constraint or a soft constraint.

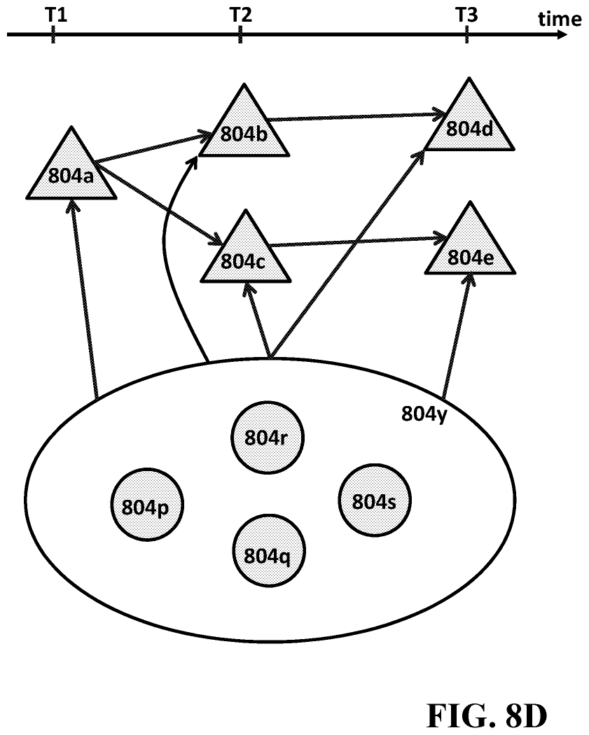

In some embodiments, the modulation of a node from its parent nodes can be based on a model, such as Bayesian probabilistic model, a regression model, a neural network model, a support vector machine, a k-nearest-neighbor algorithm, a minimax model, and a game theoretic model. In some embodiments, the modulation of a node from its parent nodes can be based on two or more models, one of which is optimally selected from two or more models by fitting a training data set. FIG. 9A shows an example where a node 901a is modulated by a node 901b based on a Bayesian model 901g and a neural network model 901h. An optimal selection may be initiated by a random selection, and the optimal selection is derived after performing a training step. In some cases, the modulation of a node from its parent nodes can be based on averaging two or more models. FIG. 9B shows another example, where a node 902a is modulated by a node 902b based on a Bayesian model 902g and by another node 902c based on a neural network model 902h.

### Funding Exchange

In some embodiments, computer systems or cloud computing services further comprise an all-inclusive terminal to access data-driven intelligence and capital to get the international arbitration claims financed. In certain embodiments, the all-inclusive terminal comprises a combination of multiple funding source networks, different funding source network layer protocols are used at each of the funding source networks. In some embodiments, the invention method further comprises a step to access multiple funding source networks. In certain embodiments, each of the multiple funding source networks comprises different funding source network layer protocols.

### Visualization

In various implementations, a language understanding system comprises a visualization process for visualizing one or more of the following: raw data, extracted features, predicted outcomes, data summaries, or processed data.

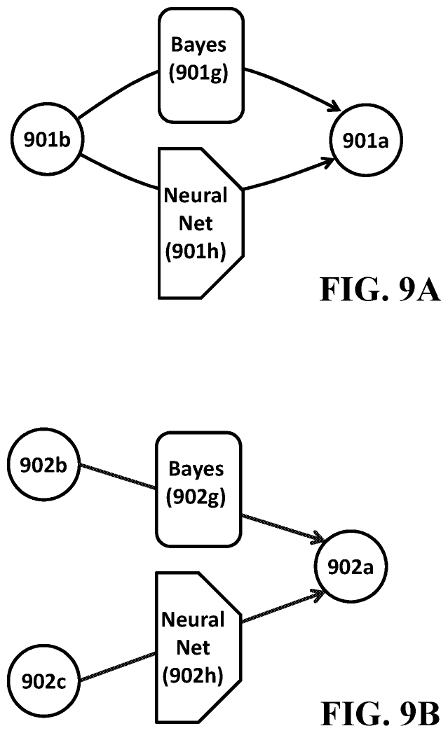

In some embodiments, a visualization process receives one or more datasets. Referring to FIG. 10, a dataset 1010 includes first data objects (e.g., 1030, 1040, 1050, etc.). In some cases, a first data object represents a feature. In some applications, a first data object represents a shared characteristic of multiple features. In some instances, a first data object represents a group. Examples of a first data object include, but not limited to, a team, a club, a patent, a portfolio, an article, a school, a district, an entity, a product, a product line, a system, a building, a geographic area, a continent, an animal, a plant, a kingdom, a tribunal, a c-suite, a company, an industry, a race, a town, a county, a state, a country, an event, an itinerary, a schedule, a time period, a spectrum, a light beam, etc.

Referring again to FIG. 10, a same dataset or another dataset (e.g., 1020) includes second data objects (e.g., 1031, 1032, 1033, 1041, 1042, 1043, 1044, 1051, 1052, etc.) associated with the first data objects (e.g., 1030, 1040, 1050, etc.). In the example of FIG. 10, second data objects 1031, 1032 and 1033 are associated with the first data object 1030; second data objects 1041, 1042, 1043 and 1044 are associated with the first data object 1040; second data objects 1051 and 1052 are associated with the first data object 1050. In some examples, an association represents a relation or a membership or both. Examples of a relation include, but not limited to, family, marriage, team, work, inventorship, authorship, employment, assignment, sport, panel, tribunal, project, program, etc. Example of a membership include, but not limited to, team members, club members, portfolio components, teachers, students, staff members, employees, jobs, tribunal members, arbitrators, attorneys, officials, product components, products, system components, rooms, floors, materials, organs, species, flowers, trees, leaves, geographic areas, continents, suppliers, clients, buyers, races, residents, citizens, towns, cities, states, counties, countries, seconds, minutes, days, months, years, frequencies, colors, etc.

In some embodiments, one or more first data objects are associated with one or more second data objects. For instance, a group (corresponding to a first data object, e.g., a tribunal) is associated with one or more group members (corresponding to one or more second data objects, e.g., arbitrators). For example, two groups (corresponding to two first data objects, e.g., two companies) are associated with one group member (corresponding to one second data object, e.g., a person used to work for both companies).

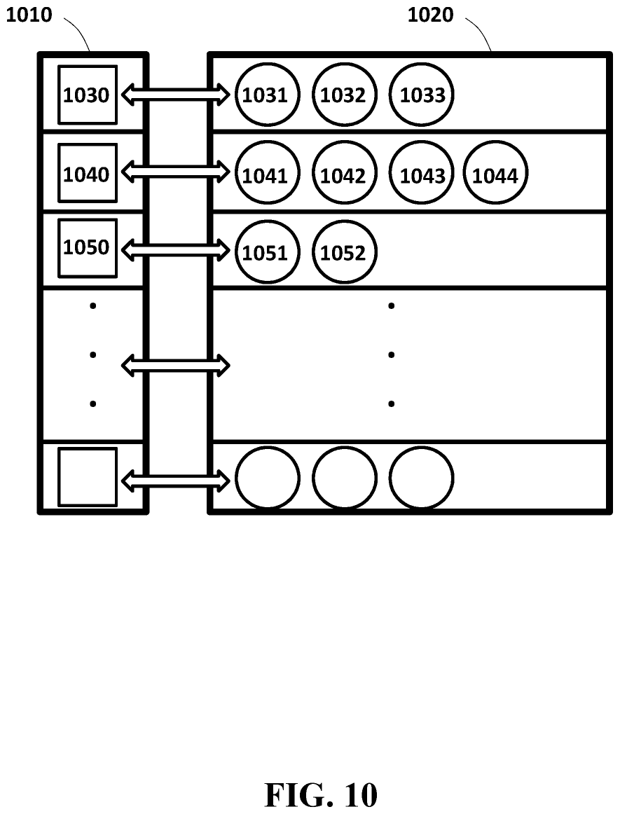

In some embodiments, a visualization process creates a graphical model to represent the data objects and the associations in given datasets. A graphical model has nodes and edges. In some cases, nodes represent second data objects (e.g., group members), and an edge links a pair of nodes when the pair of corresponding second data objects is commonly associated with a same first data object (e.g., a group). In the example shown in FIG. 11, nodes 1101, 1102 and 1103 are commonly associated with one group, so they are linked as a triangle, represented by solid lines. Similarly, nodes 1121, 1122 and 1123 are commonly associated with another group, so they are linked as a triangle, represented by doted lines. In addition, nodes 1102, 1103, 1121 and 1122 are commonly associated with a third group, so they are linked as a tetragon, represented by dashed lines. The same logic can be extended to more commonly associated nodes to form multiple-sided polygons (e.g., pentagon, hexagon, and so on).

In some cases, four or more second data objects associated with a single first data object create a complete subgraph in the graphical model; however, some applications do not necessarily create a complete subgraph to capture such an association. Referring to FIG. 11, commonly associated nodes 1102, 1103, 1121 and 1122 form a tetragon which is an incomplete subgraph. In some applications the 1102-1103-1121-1122 tetragon can be formed as a complete subgraph by adding one edge linking 1103 and 1122 and another edge linking 1102 and 1121.

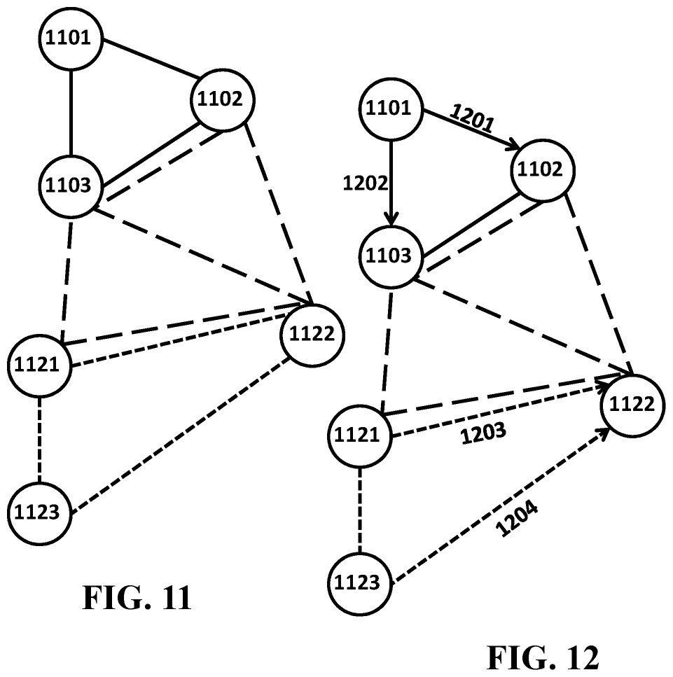

In some embodiments, a graphical model comprises an undirected subgraph, such as FIG. 11. In some embodiments, a graphical model comprises a directed subgraph, where some edges are directed and some are undirected, or all the edges are directed. FIG. 12 shows an example which replicates the graphical model from FIG. 11 but turns the edges into 1201, 1202, 1203 and 1204 into directed ones.

In general, an edge can be assigned a direction in order to capture a detailed association. For instance, a tribunal (as a first data object) includes president, claimant and defendant (as three second data objects); three linked nodes representing the president, claimant and defendant can capture the tribunal association; the edges between the president and the claimant and between the president and the defendant can be directed, and the edge between the claimant and defendant can be undirected. In another example, a class with a teacher (as a first data object) and multiple students (as second data objects) is captured by a graph, where nodes represent students and the edges among nodes represent the teacher-student associations; an edge between a teacher and a student can be directed, and an edge between two students can be undirected.

In some embodiments, a direction of an edge captures a detailed association. For example, a direction captures a hierarchy, a priority, a relative location, a relative time, a temporal sequence, a spatial sequence, a relative degree, a relative quantity, a greater-than relation, a less-than relation, an equal relation, etc.

In some embodiments, an edge encodes quantitative or qualitative, or both, information (e.g., extracted features, raw data, data summaries, statements, etc.). Examples of features encoded in an edge include, but not limited to, authorship, a document ID, an article, a title, a table of contents, a paragraph, a time, a duration, a country, an industry, a case, a dollar amount, a cost, a damage, a similarity, a dissimilarity, a distance, a training background, an opinion, an issue, an expertise, a product, a program, a firm/company, a decision, an efficiency, a procedural posture (e.g., allowing one or more depositions), a citation, a law, a treaty, a person, a history, etc. In some cases, the encoded information is numerically represented, e.g., by a vector. In some cases, the encoded information is verbally represented, e.g., by a sentence.

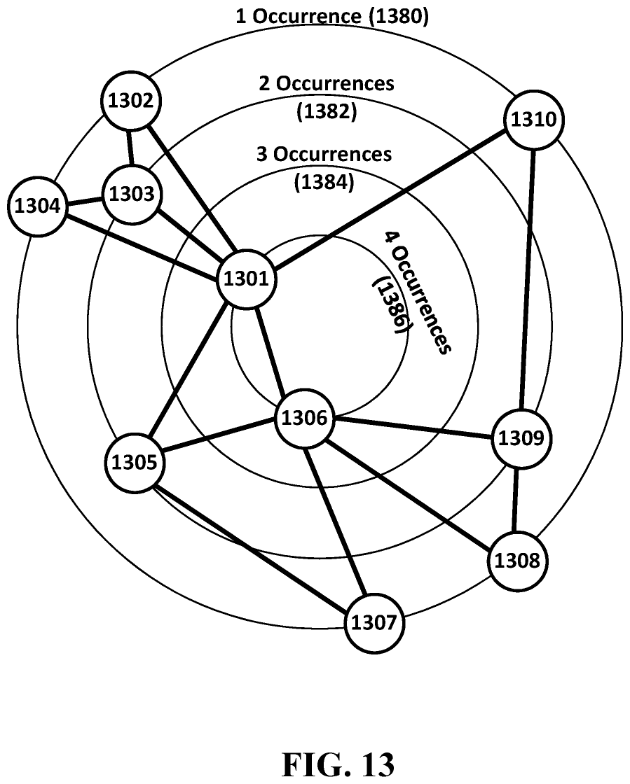

In some embodiments, a visualization process renders a graphical model overlaying on two or more contours. In a visualization, a pair of contours may or may not be concentric. FIG. 13 illustrates an example, where nodes and edges are created from an underlying dataset described below:

Association #1: Nodes 1301, 1302, 1303

Association #2: Nodes 1301, 1303, 1304

Association #3: Nodes 1301, 1305, 1306

Association #4: Nodes 1305, 1306, 1307

Association #5: Nodes 1306, 1308, 1309

Association #6: Nodes 1301, 1306, 1309, 1310

In some applications, a contour represents the number of occurrences of a second data object in the datasets, and the second data object is allocated on the contour based on its number of occurrences in the dataset. The number of the contours is determined by the maximum number of occurrences of second data objects in the datasets. Referring to FIG. 13, contours 1380, 1382, 1384 and 1386 corresponds to one, two, three and four occurrences, respectively. The nodes 1301-1310 are distributed on the contours based on their occurrences in the dataset.

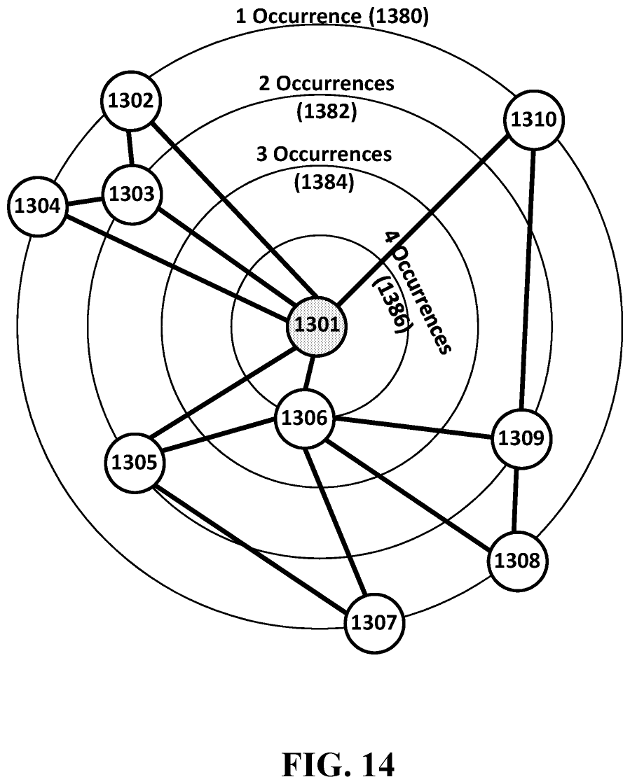

In some embodiments, a node is designated as a center of the contours. For instance, FIG. 14 replicates the visualization shown in FIG. 13 but assigns node 1301 as the center of the contours.

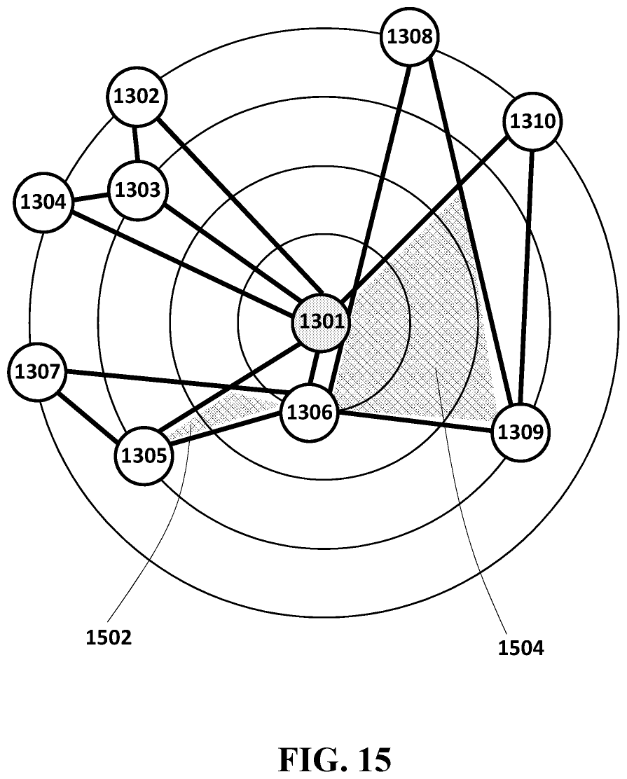

An optimization may be invoked to determine optimal locations of the nodes distributed on the contours. In some cases, the optimization minimizes an overlapping area between different subgraphs. For example, in FIG. 14 the nodes 1303, 1305 and 1309 occur twice in the dataset, and their locations on the contour 1382 may be assigned randomly; thus, an optimization is employed to optimally find their optimal placements. FIG. 15 illustrates an example replicated from FIG. 14 but places the nodes 1307 and 1308 at different locations, causing one overlapping area 1502 between triangle 1301-1305-1306 and triangle 1307-1305-1306 and another overlapping area 1504 between triangle 1308-1306-1309 and tetragon 1301-1306-1309-1310. After minimizing overlapping areas, the visualization process will find an optimal solution, resulting in that the layout shown in FIG. 14 is a better visualization than the one shown in FIG. 15.

In some embodiments, the optimization minimizes a total length of some or all edges. In some applications, the optimization minimizes a total length of the edges emitting from the center of the contours. In some embodiments, the optimization minimizes an area formed by a subgraph corresponding to a set of commonly associated nodes. An area can be computed based on a convex hull applied to the shape; in some cases, an area can be computed by dividing the shape of the subgraph into non-overlapping triangles and then summing the triangles' area.

In some embodiments, a contour is implemented as a circle, a sphere, an ellipse, a square, or a polygon. In some cases, a contour is implemented as an irregular shape. In some applications, all contours are concentric. In an embodiment, some contours are concentric, and some are not.

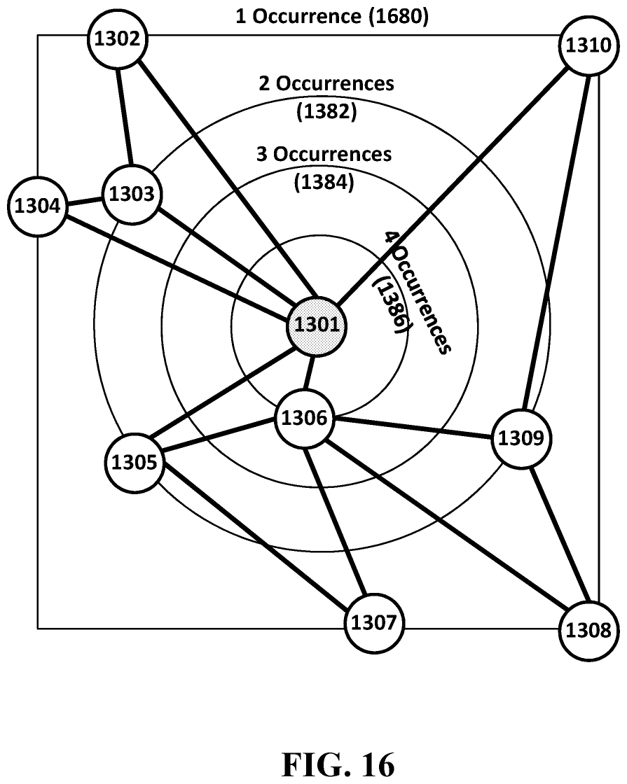

In some embodiments, two contours are realized by a same shape or by different shapes. FIG. 16 illustrates an example that replicates the visualization of FIG. 14 but replaces the contour 1380 with a rectangle 1680. Those nodes 1302, 1304, 1307, 1308 and 1310 occurring once in the dataset are now accordingly allocated on the rectangle 1680. An optimization can be applied herein to optimally lay out the graphical model on the contours 1680, 1382, 1384 and 1386.

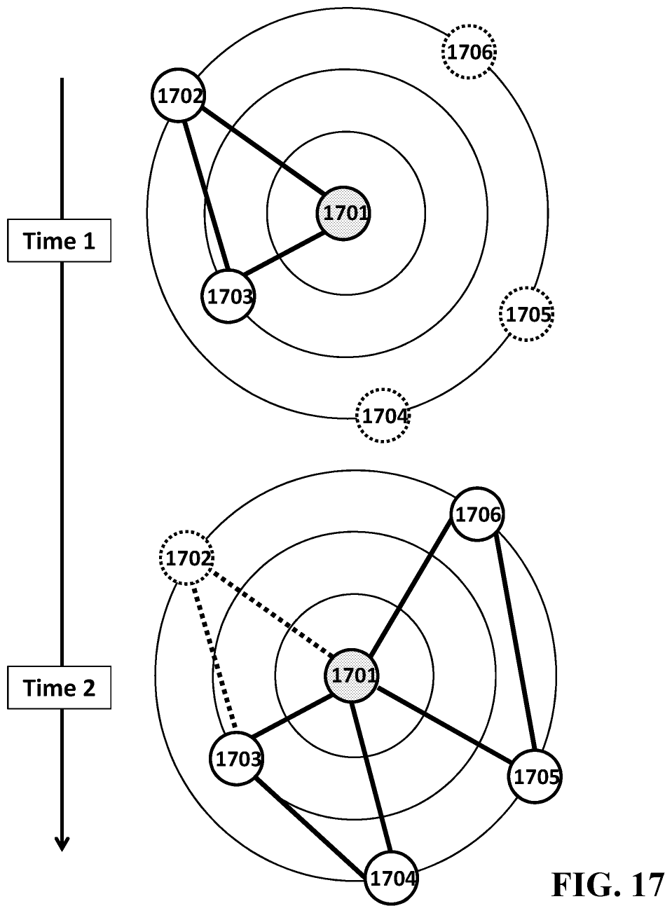

In some embodiments, a visualization process animates temporal evolution of a graphical model overlaying on contours. A dataset may contain temporal information, or it may be a time series. A temporal graphical model may contain a sequence of graphical models that corresponds to data objects at different times. FIG. 17 depicts an example where the dataset at Time 1 is visually presented as subgraph 1701-1702-1703, and the dataset at Time 2 is visually presented as subgraphs 1701-1703-1704 and 1701-1705-1706.

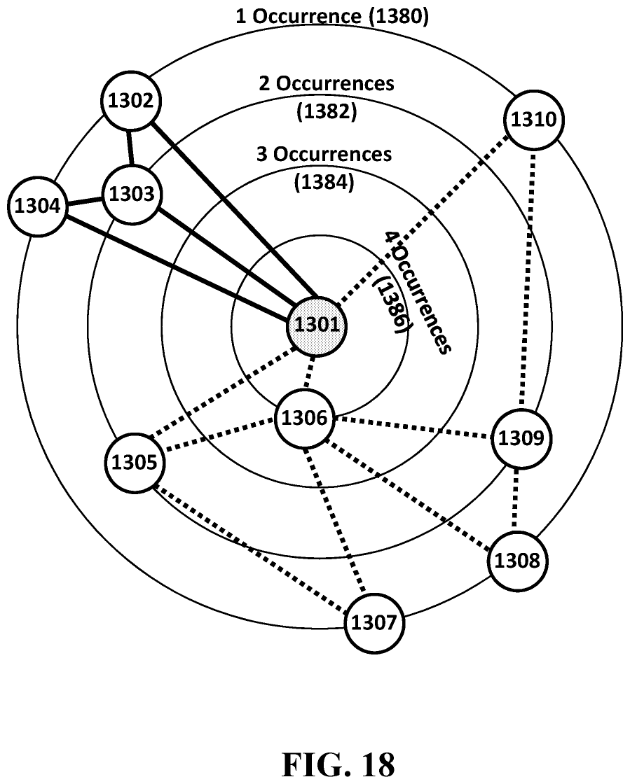

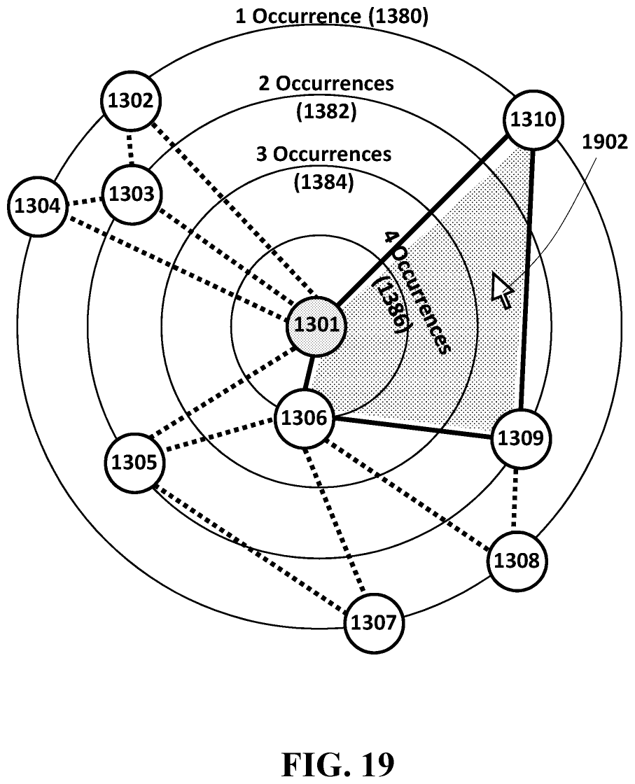

In some embodiments, the visualization process includes a user interaction capability. For example, when a user applies filtering (e.g., selecting a portion of dataset, or pointing/selecting one or more nodes, or pointing/selecting one or more edges), the visualization changes accordingly. Non-limiting examples of user interactions are described below.
(1) Interactions (e.g., filtering) with a dataset. In the example of FIG. 14, when a user selects Association #1 (with nodes 1301, 1302, 1303) and Association #2 (nodes 1301, 1303, 1304), the visualization process emphasizes the selected associations and nodes and de-emphasizes others, resulting in FIG. 18 where the selected/emphasized associations are in solid lines and others are in dotted lines. In the example of FIG. 17, a user can select a specific time and the corresponding temporal graphical model is emphasized, and/or others are de-emphasized.
(2) Interaction with a node of a graphical model. A user may select a node by clicking a mouse on top of the node or touching the node via a touchscreen. In some embodiments, the node is emphasized, and/or other nodes are de-emphasized. In some cases, the edges linking the selected node are emphasized, and/or other edges are de-emphasized.
(3) Interaction with an edge of a graphical model. A user may select an edge by clicking a mouse on top of the edge or touching the edge via a touchscreen. In some embodiments, the edge is emphasized, and/or other edges are de-emphasized. In some cases, the nodes linked by the selected edge are emphasized, and/or other nodes are de-emphasized.
(4) Interaction with a subgraph of a graphical model. A user may select a subgraph by interacting with the subgraph (e.g., clicking a mouse on top of the shape captured by the subgraph; touching the shape via a touchscreen). In some embodiments, the shape is emphasized. In some applications, the edges captured by the selected subgraph are emphasized, and/or other edges are de-emphasized. In some cases, the nodes or edges or both captured by the selected subgraph are emphasized, and/or other nodes or edges or both are de-emphasized. Referring to FIG. 19 which replicates the example in FIG. 14, when a mouse 1902 clicks on top of tetragon 1301-1306-1309-1310, the tetragon is shaded for the emphasis purpose; the edges captured by the tetragon are turned into solid lines and remaining edges become dashed lines.
(5) Interaction with a contour. A user may select a contour by interacting with the contour (e.g., clicking a mouse on top of the contour; touching the contour via a touchscreen). In some embodiments, the contour is emphasized, and/or other contours are de-emphasized. In some applications, the nodes on the selected contour are emphasized, and/or other nodes are de-emphasized. In some cases, the edges directly connecting with the nodes on the selected contour are emphasized, and/or other edges are de-emphasized.

The visualization of emphasis may be realized by adding and thickening or highlighting or color-changing or style-changing or shading or texturing (or a combination of them) a selected component. Visualization of de-emphasis may be realized by thinning or darkening or graying or color-changing or de-coloring or style-changing or dashing or dotting or shading or removing (or a combination of them) a non-selected component.

Other implementations are also within the scope of the claims.

1. A computer-implemented method comprising:
(a) receiving, by a computing device, a dataset, the dataset comprising:
(1) two or more first data objects, and
(2) two or more second data objects associated with the two or more first data objects, wherein a first data object is associated with at least two second data objects; and
(b) rendering, by a computing device, a graphical model overlaying on two or more contours to visualize associations between the two or more first data objects and the two or more second data objects.

2. (canceled)

3. (canceled)

4. (canceled)

5. The method of claim 1, comprising creating the graphical model, wherein the graphical model having nodes and edges.

6. (canceled)

7. (canceled)

8. The method of claim 5, wherein creating the graphical model comprises (a) representing a second data object by a node, (b) assigning an edge to a pair of nodes when a pair of second data objects represented by the pair of nodes is commonly associated with a first data object, (c) assigning edges to a group of second data objects by forming the group of second data objects as a complete graph in the graphical model, (d) assigning edges to a group of second data objects by forming the group of second data objects as an incomplete graph in the graphical model, (e) assigning edges to a group of second data objects by forming the group of second data objects as a bipartite graph in the graphical model, (f) assigning edges to a group of second data objects by forming the group of second data objects as a planer graph in the graphical model, (g) assigning edges to a group of second data objects by forming the group of second data objects as a directed graph in the graphical model, or (h) grouping two or more edges between a pair of nodes into a hyperedge.

9. The method of claim 1, wherein a contour represents a number of occurrences of a second data object in the dataset.

10. The method of claim 1, wherein a number of the contours is determined by a maximum number of occurrences of second data objects in the dataset.

11. (canceled)

12. (canceled)

13. The method of claim 1, wherein two of the contours are concentric.

14. (canceled)

15. (canceled)

16. (canceled)

17. (canceled)

18. (canceled)

19. (canceled)

20. The method of claim 1, comprising providing, by a computing device, a user interface for a user to interact with a component of the graphical model.

21. The method of claim 20, wherein the user applies filtering on the dataset in response to the user interacting with a component of the graphical model.

22. The method of claim 21, wherein the rendering, in response to the user selecting a node of the graphical model, (a) emphasizes the selected node, (b) emphasizes nodes of the graphical model directly linking to the selected node, (c) de-emphasizes a node of the graphical model not directly linking to the selected node, (d) de-emphasizes an edge of the graphical model not linking the selected node, (e) emphasizes the selected edge, (f) emphasizes nodes of the graphical model directly linking by the selected edge, (g) de-emphasizes a node of the graphical model not directly linking by the selected edge, (h) de-emphasizes a non-selected edge of the graphical model, (i) emphasizes the area captured by the selected subgraph, (j) emphasizes the nodes of the selected subgraph, or (k) emphasizes the edges of the selected subgraph.

23. The method of claim 1, comprising providing, by a computing device, a user interface for a user to select a contour.

24. The method of claim 23, wherein the rendering, in response to the user selecting the contour, (a) emphasizes the contour, (b) de-emphasizes a non-selected contour, (c) emphasizes a node on a selected contour, (d) de-emphasizes a node on a non-selected contour, (e) emphasizes an edge directly connecting to a node on a selected contour, or (f) de-emphasizes an edge connecting to both nodes on a non-selected contour.

25. The method of claim 1, comprising providing, by a computing device, a user interface for a user select a time during a time course covering the dataset.

26. The method of claim 25, wherein the rendering, in response to the user selecting the time, (a) emphasizes a subgraph of the graphical model corresponding to data objects present at the selected time, or (b) de-emphasizes components of the graphical model not corresponding data objects present at the selected time.

27. (canceled)

28. (canceled)

29. (canceled)

30. (canceled)

31. (canceled)

32. (canceled)

33. (canceled)

34. (canceled)

35. (canceled)

36. (canceled)

37. A method comprising:
(a)receiving, by a computing device, one or more documents,
(b) extracting, by a computing device, two or more features from the one or more documents, and
(c)predicting, by a computing device, two or more outcomes associated with the one or more documents based on the two or more features.

38. The method of claim 37, wherein extracting two or more features is based on a language understanding model.

39. The method of claim 38, wherein the language understanding model comprises a neural language model.

40. The method of claim 37, wherein predicting two or more outcomes is based on a network model, the network model comprising nodes representing the two or more outcomes and the two or more features and edges representing modulations among nodes.

41. The method of claim 40, wherein the network model arranges the two or more outcomes in terms of temporal occurrences.

42. The method of claim 41, wherein a first outcome at a first temporal occurrence is modulated by (a) outcomes at a second temporal occurrence immediately preceding the first temporal occurrence, or (b) by outcomes and features at a second temporal occurrence immediately preceding the first temporal occurrence.

43. The method of claim 41, wherein (a) two outcomes taking place at a same temporal occurrence are independent, (b) each outcome is modulated by at least one feature, or (c) each outcome is modulated by all of the two or more features.

44. The method of claim 40, wherein the network model arranges the two or more features (a) without a temporal occurrence, or (b) as independent variables.

45. The method of claim 40, wherein modulation of a node by one or more upstream nodes is based on (a) a Bayesian probabilistic model, (b) a regression model, (c) a neural network model, (d) a game theoretic model, (e) two or more models, the two or more models comprising a Bayesian probabilistic model and a neural network model, or (f) a model randomly selected from two or more models by fitting a training data set, the two or more models comprising a Bayesian probabilistic model and a neural network model.
